(19) United States
(12) Patent Application Publication
(10) Pub. No.: US 2025/0100421 A1
(43) Pub. Date: Mar. 27, 2025

(54) ENERGY STORAGE SYSTEM

(71) Applicant: Siemens Energy Global GmbH & Co. KG, Erlangen (DE)

(72) Inventors: Andreas Junglewitz, Hamburg (DE); Matthias Wiese, Hamburg (DE)

(21) Appl. No.: 18/730,856

(22) PCT Filed: Dec. 23, 2022
(86) PCT No.: PCT/EP2022/087695

§ 371 Date: Jul. 22, 2024

(30) Foreign Application Priority Data
Jan. 20, 2022 (DE) 10 2022 200 640.2

(51) Int. Cl. B60L 58/18; H01M 10/42; H01M 10/44; H02J 7/00; H02J 7/34

(52) U.S. Cl. CPC B60L 58/18; H01M 10/425; H01M 10/441; H02J 7/00047; H02J 7/342; B60L 2200/32; H01M 2220/20

(57) ABSTRACT

An energy storage system for a vehicle is operated along a route having a plurality of sections of different lengths and is charged at stopping points between two successive sections. The system contains a first battery having a first charging-rate and a second battery having a second charging-rate, the second charging-rate being higher than the first charging-rate. The energy storage system further has a control system configured such that the first and the second batteries are charged at the stopping points, that the first and the second batteries are at least partly discharged on longer than average sections of the route, and that the first battery is charged by the second battery on at least some of the other sections. Furthermore, a vehicle having such an energy storage system, and a method for operating a vehicle having such an energy storage system are envisioned.

The invention relates to an energy storage system for a vehicle, to a vehicle having an energy storage system and to a method for operating a vehicle having an energy storage system. In this case, a plurality of cells form a battery and a plurality of batteries, of which at least some of the C-rates are different, form a module.

The object of the invention is to provide an improved energy storage system for vehicles that is able to be produced as simply and cost-effectively as possible. A further object of the invention is to provide a vehicle having such an energy supply system. Finally, it is an object of the invention to specify a corresponding method for operating a vehicle having an energy storage system.

There are two fundamentally different battery types: batteries having comparatively low C-rates charge with comparatively low current over a comparatively long time. Batteries having comparatively high C-rates are able to be charged in a comparatively short time with comparatively high current. Batteries having comparatively low C-rates have a higher capacity, are less expensive and would be advantageous for customers. The C-rate is selected according to the use profile and the shortest available charging time and the following operating cycle. If the driving profile is composed of one long segment and then a plurality of short segments, the long segment determines the total capacity of the battery (size) and the short stay at the small segments determines the magnitude of the C-rate. If only one C-rate is used, the total required capacity would have to be installed according to the short segment with batteries with the high C-rate.

The invention achieves the object directed to an energy storage system by provision being made, in the case of such an energy storage system for a vehicle, which is operated along a route having a plurality of sections of different lengths, and is charged at stopping points between two successive sections, comprising a first battery having a first C-rate and a second battery having a second C-rate, wherein the second C-rate is higher than the first C-rate, for the energy storage system to comprise a control system that is configured in such a way that the first and the second battery are charged at the stopping points, that the first and the second battery are at least partially discharged on sections of the route that are longer than average, and that the first battery is charged by the second battery on at least some of the remaining sections.

The invention therefore solves the problem by virtue of the energy storage system comprising a combination of batteries having high and low C-rates. In this case, both battery types are discharged on a long segment. In the event of short-term charging, the batteries having a high C-rate are fully charged, whereas the others only receive a small partial charge. During operation on a first small segment, the energy from the batteries having a high C-rate is used. 3 At the same time, some of the energy from the fully charged batteries is used in order to also further charge the batteries having a low C-rate during operation. As a result of this combination of batteries and energy management, after undertaking a plurality of short charging operations and short operating segments, a further long segment, which requires the capacities of all the batteries, is able to be undertaken without needing a long charging phase for the batteries having a low C-rate. In this context, at a constant speed, “length” is a synonym for required energy. Different energy requirements may also result from different speeds, resistances (wind) or height differences (ascent, descent) for sections of the same length.

In one advantageous embodiment of the invention, the first energy storage capacity of the first battery is two to nine times as great as the second energy storage capacity of the second battery. This ratio depends on the route lengths or speeds (required energy) and the selected C-rates.

In one further advantageous embodiment of the invention, the first battery and the second battery are arranged in such a way that the second battery is more easily accessible than the first battery. In this case, the invention is based on the knowledge that the number of charging cycles during operation for batteries having a high C-rate is considerably higher than for batteries having a low C-rate, and therefore the life expectancy is correspondingly lower, which leads to replacement being needed earlier (higher OPEX). In the case of a combination of two very different C-rates, the service life is also correspondingly different, which is able to be exploited for different accommodation on board the vehicle, for example a ship. Therefore, batteries having a low C-rate and a correspondingly higher service life are able to be accommodated in spaces that are more difficult to access, e.g. spaces close to the keel, whereas the batteries having a shorter service life should be accommodated in spaces that are easier to access.

The object directed at a vehicle is achieved by a vehicle having an energy storage system according to the invention.

The object directed at a method is achieved by a method for operating a vehicle having an energy storage system, the energy storage system comprising a first battery having a first C-rate and a second battery having a second C-rate, wherein the second C-rate is higher than the first C-rate, wherein the vehicle is operated along a route having a plurality of sections of different lengths and the energy storage system is charged at stopping points between two successive sections, wherein the first and the second battery are charged at the stopping points, the first and the second battery are at least partially discharged on sections of the route that are longer than average, and in that the first battery is charged by the second battery on at least some of the remaining sections.

The second battery is advantageously fully charged at the stopping points.

In the art, batteries having a high C-rate are used for short cycles and batteries having a low C-rate are used for long cycles. The particular feature of the present invention is the energy management that uses energy from the batteries that are able to be charged rapidly in order to ensure a long charging cycle for the batteries having a low C-rate. As a result, an operation is made possible that has charging and discharging cycles of different lengths, as may occur in the case of ferries having multiple different stopping points, for example, and also a relatively large number of batteries having a low C-rate. This leads to a cost reduction in the battery equipment (CAPEX) and to a lower battery volume/weight, since batteries having a lower C-rate have a higher capacity per volume/weight than batteries having a high C-rate. 2 The required cooling capacity for the total battery capacity is also reduced if only a smaller portion of the battery capacity has to be operated with a high C-rate—and thus relatively high waste heat. The safety requirements for batteries having a high C-rate are also typically higher than for those having a low C-rate.

The invention will be explained in greater detail by way of example with reference to the drawings, in which, schematically and not to scale:

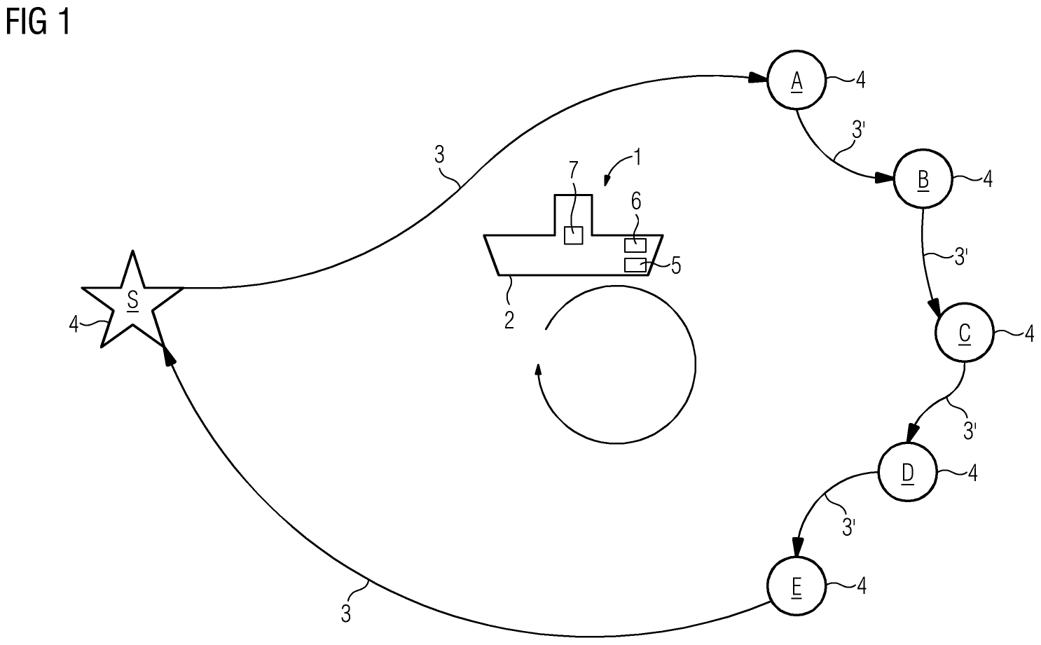

FIG. 1 shows a possible example of the journey of a ferry, and

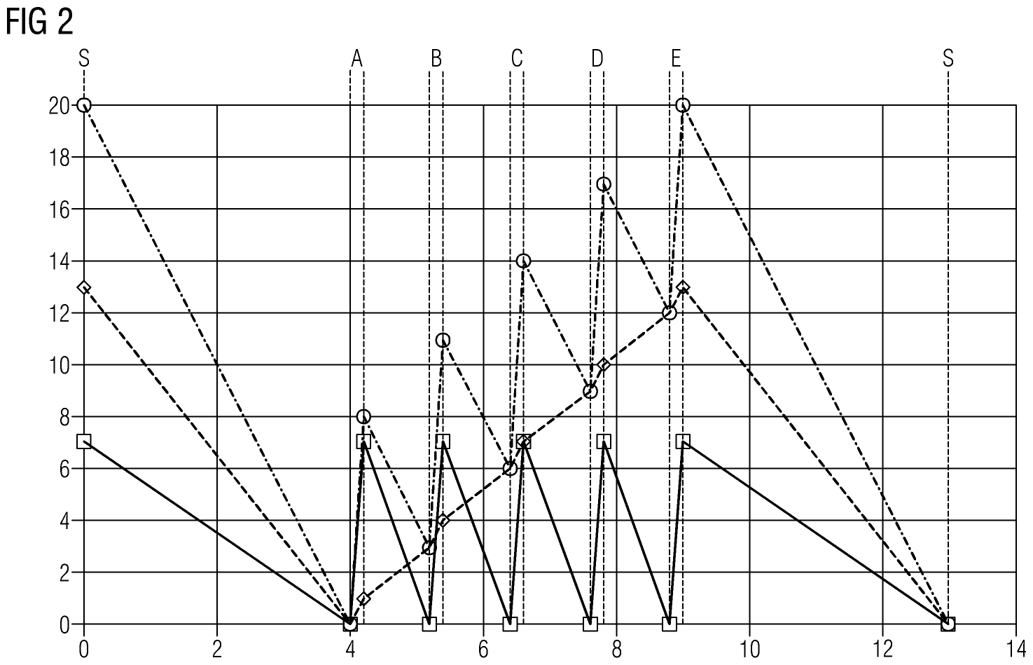

FIG. 2 shows an exemplary profile of the state of charge of the first and the second battery and of the total state of charge over time.

FIG. 1 schematically shows, by way of example, the route of a ferry 2 having an energy storage system 1 according to the invention. The route contains a plurality of sections 3, 3′ of different lengths, with stopping points 4 between two successive sections 3, 3′, at which the energy storage system 1 is able to be charged. The energy storage system 1 comprises a first battery 5 having a first C-rate and a second battery 6 having a second C-rate, wherein the second C-rate is higher than the first C-rate. The energy storage system 1 also comprises a control system 7 that is configured in such a way that the first battery 5 and the second battery 6 are charged at the stopping points 4, that the first battery 5 and the second battery 6 are at least partially discharged on sections 3 of the route that are longer than average, and that the first battery 5 is charged by the second battery 6 on at least some of the remaining sections 3′.

In the example in FIG. 1, the first battery 5 and the second battery 6 are fully charged at the starting point S. The first battery 5 and the second battery 6 are fully discharged on the first long segment 3 between the starting point S and stopping point A. In the event of short-term charging at stopping point A, the second battery 6, that is to say the battery having a high C-rate, is fully charged, whereas the first battery 5 only contains a small partial charge at the end of the charging operation. The energy from the second battery 6, that is to say the battery having a high C-rate, is used for operation of the ferry 2 on the first small section 3′ between stopping point A and stopping point B. At the same time, some of the energy from this second battery 6 that is fully charged upon leaving stopping point A is used in order to also further charge the first battery 5 having a low C-rate during operation of the ferry 2. In the example in FIG. 1, upon arrival at stopping point B, the second battery 6 is empty and the first battery 5 is partially charged to a comparatively low level, but to a greater extent than upon leaving stopping point A. During the time that the ferry is at stopping point B, in the exemplary embodiment in FIG. 1, just like at stopping point A, both batteries 5 and 6 are charged. The first battery 5 is charged further, starting from a comparatively low level; the second battery 6 is fully charged starting from zero.

The described procedure is repeated on the next short sections 3′ and at the stopping points 4, with the result that, upon leaving stopping point E, both the first battery 5 and the second battery 6 are fully charged and it is possible to travel the long section 3 between stopping point E and destination S.

FIG. 2 shows an exemplary profile of the state of charge of the first battery 5 (-♦-) and the second battery 6 (-▪-) and the corresponding profile of the total state of charge (-▴-) over time. It can easily be seen here how the first battery 5 is charged both at stopping points 4 (S, A, B, C, D, E) and at the short distances 3′ between these stopping points 4, whereas the second battery 6 is only charged at stopping points 4 themselves. The table below shows corresponding charging and discharging operations of the batteries on the sections 3 and 3′ and at the stopping points 4 (S, A, B, C, D, E):

| | first battery 5 | second battery 6 | |
|---|---|---|---|
| | (low C-rate) | (high C-rate) | |
| S-A, E-S | discharge | discharge | |
| A, B, C, D, E, S | charge | charge | |
| A-B, B-C, C-D, D-E | charge | discharge | |
| required capacity | 0 | 20 | units |
| according to the prior art | | | |
| required capacity | 13 units | 7 | units |

according to
the invention

1-6. (canceled)

7. An energy storage system for a vehicle, being operated along a route having a plurality of sections of different lengths, and is charged at stopping points between two successive said sections, the energy storage system comprising:
a first battery having a first charging-rate;
a second battery having a second charging-rate, wherein the second charging-rate is higher than the first charging-rate; and
a control system configured such that said first battery and said second battery are charged at the stopping points, said first battery and said second battery are at least partially discharged on the sections of the route that are longer than average, and that said first battery is charged by said second battery on at least some of remaining ones of the sections.

8. The energy storage system according to claim 7, wherein a first energy storage capacity of said first battery is two to nine times as great as a second energy storage capacity of said second battery.

9. The energy storage system according to claim 7, wherein said first battery and said second battery are disposed such that said second battery is more easily accessible than said first battery.

10. A vehicle, comprising:
the energy storage system according to claim 7.

11. A method for operating a vehicle having an energy storage system, the energy storage system having a first battery with a first charging-rate and a second battery having a second charging-rate, wherein the second charging-rate is higher than the first charging-rate, wherein the vehicle is operated along a route having a plurality of sections of different lengths and the energy storage system is charged at stopping points between two successive said sections, which comprises the steps of:
charging the first battery and the second battery at the stopping points;
partially discharging the first and the second battery on the sections of the route that are longer than average; and
charging said first battery by the second battery on at least some of remaining ones of the sections.

12. The method according to claim 11, wherein said second battery is fully charged at the stopping points.
